(19) United States
(12) Patent Application Publication
(10) Pub. No.: US 2018/0305006 A1
(43) Pub. Date: Oct. 25, 2018

(54) PITCH BEARING ASSEMBLY FOR ROTOR SYSTEM AND AIRCRAFT

(71) Applicant: Sikorsky Aircraft Corporation, Stratford, CT (US)

(72) Inventors: Ryan Lehto, Crowley, TX (US); Robert D Higbie, Haslet, TX (US); James Everett McCollough, Arlington, TX (US); Joshua R. Richards, Fort Worth, TX (US); Bryan Kenneth Baskin, Arlington, TX (US)

(21) Appl. No.: 15/902,122

(22) Filed: Feb. 22, 2018

Related U.S. Application Data
(60) Provisional application No. 62/489,550, filed on Apr. 25, 2017.

(51) Int. Cl. B64C 27/37

(52) U.S. Cl. CPC B64C 27/37

(57) ABSTRACT

A pitch bearing assembly includes an inboard pitch bearing including an inner race and an outer race, the outer race including a radially outwardly protruding tab, and an outboard end of the inboard pitch bearing including a plurality of rotation transmitting features. An outboard pitch bearing of the pitch bearing assembly includes an inner race and an outer race, an inboard end of the outer race of the outboard pitch bearing including a plurality of rotation transmitting features. A coupler of the pitch bearing assembly has an inboard end and an outboard end, the inboard end of the coupler having a plurality of rotation transmitting features engageable with the rotation transmitting features of the inboard pitch bearing, the outboard end of the coupler having a plurality of rotation transmitting features engageable with the rotation transmitting features of the outboard pitch bearing.

### CROSS-REFERENCE TO RELATED APPLICATION

This application claims priority to U.S. Provisional Patent Application No. 62/489,550 filed on Apr. 25, 2017. The entire contents of U.S. Provisional Patent Application No. 62/489,550 are incorporated herein by reference.

### STATEMENT OF FEDERAL SUPPORT

This invention was made with Government support under Agreement No. W911W6-13-2-0003 for the Joint Multi-Role Technology Demonstrator Phase I— Air Vehicle Development program. The Government has certain rights in the invention.

### BACKGROUND

The present disclosure relates to a rotary-wing aircraft, and more particularly, a pitch bearing assembly for a rotor system of a rotary-wing aircraft.

Compound helicopters generally include a main rotor assembly with coaxial, counter-rotating main rotors and a propulsor. The main rotor assembly is disposed at an upper portion of the helicopter airframe and the propulsor is disposed at a tail of the helicopter. The main rotor assembly generates lift, thrust and yaw control while the propulsor generally assists with generation of thrust for forward flight. Pitch change of rotor blades may be accommodated by an elastomeric bearing. But for large pitch ranges where elastomeric bearings would exceed packaging constraints, such as for a propulsor, inboard and outboard pitch change bearings can be employed.

While such arrangements have generally satisfied the requirements for traditional rotor systems, the art would be receptive to improved methods and systems for rotor systems.

### BRIEF DESCRIPTION

According to an embodiment, a pitch bearing assembly includes an inboard pitch bearing including an inner race and an outer race, the outer race including a radially outwardly protruding tab, and an outboard end of the inboard pitch bearing including a plurality of rotation transmitting features. An outboard pitch bearing of the pitch bearing assembly includes an inner race and an outer race, an inboard end of the outer race of the outboard pitch bearing including a plurality of rotation transmitting features. A coupler of the pitch bearing assembly has an inboard end and an outboard end, the inboard end of the coupler having a plurality of rotation transmitting features engageable with the rotation transmitting features of the inboard pitch bearing, the outboard end of the coupler having a plurality of rotation transmitting features engageable with the rotation transmitting features of the outboard pitch bearing.

In addition to one or more of the features described above, or as an alternative, in further embodiments the rotation transmitting features of the inboard end and outboard end of the coupler and the rotation transmitting features of the outer races of the inboard and outboard pitch bearings include castellations.

In addition to one or more of the features described above, or as an alternative, in further embodiments the outer race of the outboard pitch bearing does not include a radially outwardly protruding tab.

In addition to one or more of the features described above, or as an alternative, in further embodiments the pitch bearing assembly is disposable between a hub arm and a rotor blade of a rotor system, the inner races are rotationally fixable to the hub arm, and the outer races are rotationally fixable to the rotor blade.

According to an embodiment, a rotor system includes a hub arm, a blade extending in a longitudinal direction over the hub arm; and, a pitch bearing assembly disposed between the hub arm and the blade, the pitch bearing assembly including an interior portion rotationally locked to the hub arm, an exterior portion rotationally locked to the blade, the exterior portion rotatably movable with respect to the interior portion; wherein the blade is axially translatable in the longitudinal direction with respect to the pitch bearing assembly.

In addition to one or more of the features described above, or as an alternative, in further embodiments the pitch bearing assembly includes an inboard pitch bearing having an outer race at the exterior portion of the pitch bearing assembly; an outboard pitch bearing having an outer race; and, a coupler rotationally fixing the outer race of the outboard pitch bearing to the outer race of the inboard pitch bearing.

In addition to one or more of the features described above, or as an alternative, in further embodiments the outer race of the inboard pitch bearing is rotationally fixed to the blade.

In addition to one or more of the features described above, or as an alternative, in further embodiments the blade includes a tab-receiving area and the outer race of the inboard pitch bearing includes a radially protruding tab seated with the tab-receiving area, the tab rotationally fixing the outer race of the inboard pitch bearing to the blade, and the tab-receiving area permitting axial translation of the blade relative to the pitch bearing assembly.

In addition to one or more of the features described above, or as an alternative, in further embodiments the tab-receiving area is a notch that extends from an inboard end of the blade.

In addition to one or more of the features described above, or as an alternative, in further embodiments the coupler includes an inboard end having a rotation transmitting feature in engagement with a rotation transmitting feature on the outer race of the inboard pitch bearing, and an outboard end having a rotation transmitting feature in engagement with a rotation transmitting feature on the outer race of the outboard pitch bearing.

In addition to one or more of the features described above, or as an alternative, in further embodiments the rotation transmitting features of the inboard end and outboard end of the coupler and the rotation transmitting features of the outer races of the inboard and outboard pitch bearings include castellations.

In addition to one or more of the features described above, or as an alternative, in further embodiments the pitch bearing assembly further includes an inspection path that extends from an exterior of the coupler to an interior of the coupler, the inspection path permitting inspection of at least one of the inboard pitch bearing and the outboard pitch bearing through the coupler.

In addition to one or more of the features described above, or as an alternative, in further embodiments the coupler includes an aperture providing the inspection path.

In addition to one or more of the features described above, or as an alternative, in further embodiments the coupler includes castellations engageable with castellations on the inboard and outboard pitch bearings, and a longitudinal gap is disposed between at least one of the castellations and one of the coupler, the inboard pitch bearing, and the outboard pitch bearing to provide the inspection path.

In addition to one or more of the features described above, or as an alternative, in further embodiments the inboard pitch bearing includes a spherical bearing and the outboard pitch bearing includes a cylindrical bearing.

In addition to one or more of the features described above, or as an alternative, in further embodiments the rotor system further includes a tension torsion strap disposed within the hub arm, the blade axially translatable with the tension torsion strap due to centrifugal force.

In addition to one or more of the features described above, or as an alternative, in further embodiments a method of inspecting the rotor system, where the pitch bearing assembly of the rotor system includes an inboard pitch bearing and an outboard pitch bearing rotationally fixed by a coupler, includes: after the pitch bearing assembly is assembled on the hub arm, employing an inspection path that extends from an exterior of the coupler to an interior of the coupler and at least one of an inboard side of the outboard pitch bearing and an outboard side of the inboard pitch bearing; and inspecting a seal of at least one of the outboard pitch bearing and the inboard pitch bearing using the inspection path.

According to an embodiment, a rotary-wing aircraft includes an airframe; a rotor extending from the airframe and defining an axis of rotation; a rotor hub surrounding the rotor, the rotor hub having a plurality of hub arms; a plurality of rotor blades respectively engaged with the plurality of hub arms; and, each blade extending in a longitudinal direction over a respective hub arm; and, a pitch bearing assembly disposed between each hub arm and rotor blade, each pitch bearing assembly including an interior portion rotationally fixed to the hub arm and an exterior portion rotationally fixed to the blade, the exterior portion rotatably movable with respect to the interior portion; wherein the plurality of rotor blades is axially translatable in the longitudinal direction with respect to each pitch bearing assembly.

In addition to one or more of the features described above, or as an alternative, in further embodiments the pitch bearing assembly includes: an inboard pitch bearing having an outer race; an outboard pitch bearing having an outer race; and, a coupler rotationally fixing the outboard pitch bearing to the inboard pitch bearing.

In addition to one or more of the features described above, or as an alternative, in further embodiments the rotary-wing aircraft further includes a tension torsion strap disposed within the hub arm, the blade axially translatable with the tension torsion strap due to centrifugal force.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic diagram of an example of a rotary-wing aircraft;

FIG. 2 is a schematic partial sectional view of a rotor system according to an embodiment;

FIG. 3 is a perspective view of an embodiment of an inboard pitch bearing for the rotor system of FIG. 2;

FIG. 4 is a perspective view of an embodiment of an outboard pitch bearing for the rotor system of FIG. 2;

FIG. 5 is a perspective view of an embodiment of a coupler for the rotor system of FIG. 2;

FIG. 6 is a perspective view of an inboard portion of a rotor blade for the rotor system of FIG. 2;

FIG. 7 is a perspective and partial sectional view of the rotor system of FIG. 2; and,

FIG. 8 is a perspective and partial view of a rotor system according to another embodiment.

### DETAILED DESCRIPTION

As will be further described below, embodiments of a rotor system include a blade held to a rotor hub by means of a tension torsion strap and supported by a plurality of roller element pitch bearings. The blade is allowed to translate axially as the centrifugal forces increase with rotor speed while the radial position of the pitch bearing outer races is held constant with respect to blade. A tabbed feature on the outer race of the inboard pitch bearing at the inboard end of the blade nests in an open slot in the inboard end of the blade to link them together. The tab and notch feature constrain the outer race of the inboard pitch bearing to the blade in the radial direction while allowing axial translation of the blade relative to the outer race. The outer races of the outer pitch bearings inside the blade further outboard of the inboard pitch bearing also need to be constrained in the radial direction so the outboard pitch bearings are linked to the tabbed outer race of the inboard pitch bearing by way of a coupler with castellations which is designed to mate up with castellations on the outer races of both inboard and outboard pitch bearings.

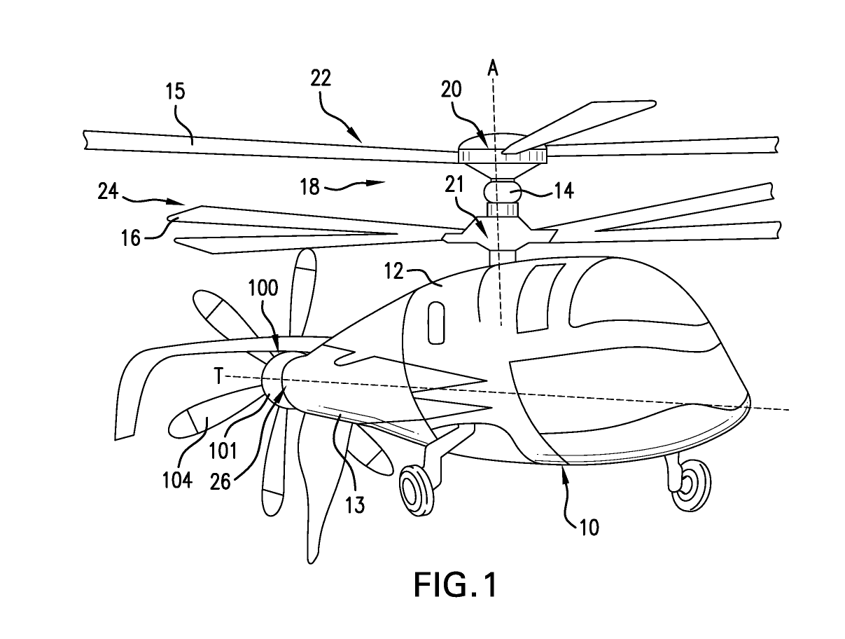

FIG. 1 depicts an embodiment of a rotary wing, vertical takeoff and landing (VTOL) aircraft 10. Aircraft 10 includes an airframe or fuselage 12 having a plurality of surfaces (not separately labeled) with an extending tail 13. A coaxial main rotor assembly 18, located at the fuselage 12, rotates about a main rotor axis A via one or more rotor shafts positioned internally of fairing 14. Main rotor assembly 18 is driven by a power source, for example, one or more engines via a gearbox. The engine generates power by which the main rotor assembly 18 and a propulsor 26 are operated and the gearbox (transmission system) transmits the generated power from the engine to the main rotor assembly 18 and the propulsor 26. A flight computer controls various operations of the engine, the transmission system and the collective and cyclic controls of the main rotor assembly 18 and the propulsor 26 in accordance with pilot inputted commands, control algorithms and current flight conditions. Main rotor assembly 18 includes an upper rotor assembly 22 that may be driven in a first direction (e.g., counter-clockwise) about the main rotor axis A, and a lower rotor assembly 24 that may be driven in a second direction (e.g., clockwise) about the main rotor axis A, opposite to the first direction (i.e., counter rotating rotors).

In accordance with an exemplary embodiment, upper rotor assembly 22 includes a first plurality of rotor blades 15 supported by a first or upper rotor hub 20. Lower rotor assembly 24 includes a second plurality of rotor blades 16 supported by a second, or lower rotor hub 21. Each of the upper rotor blades 15 and each of the lower rotor blades 16 can be pivoted about a respective longitudinal axis thereof by way of collective and cyclic commands to execute flight control (e.g., lift, pitch, roll and yaw control) of the aircraft 10. In some embodiments, aircraft 10 may include a translational thrust system or propulsor 26 having a rotor system 100 located at extending tail 13 to provide translational thrust (forward or rearward) for aircraft 10. Rotor system 100 includes a plurality of blades 104 extending from rotor hub 101.

Although a particular aircraft configuration is illustrated in this non-limiting embodiment, other rotary wing aircraft may also benefit from embodiments of the invention. Although the dual rotor system is depicted as coaxial, other embodiments may include dual rotor aircraft having non-coaxial rotors. Further, while a particular aircraft configuration is illustrated in this non-limiting embodiment, other rotary wing aircraft will also benefit from embodiments of the invention. Moreover, aspects may be used in non-rotary wing aircraft, including fixed wing aircraft and tilt wing aircraft using rotor blades and/or propellers, and may be used in maritime propulsion systems, wind turbines and the like.

Propulsor 26, may be connected to, and rotatably driven by, an engine via a gearbox. Rotor system 100 may be mounted to the tail 13 with a translational thrust axis T, oriented substantially horizontal and parallel to a longitudinal axis of the aircraft 10 (including tail 13), to provide thrust for high-speed flight. The term “parallel” should be understood to include a translational thrust axis that is coincident with the longitudinal axis. While the propulsor rotational axis T is shown generally in parallel with a longitudinal axis of the tail portion 13, it is understood that the axis T can also be non-parallel with the longitudinal axis of the tail portion 13 in other aspects. Translational thrust axis T corresponds to the axis of rotation of rotor system 100, and corresponds to a longitudinal axis of a rotor shaft of the rotor system 100. While shown in the context of a pusher-prop configuration, it is understood that the rotor system 100 could also be a more conventional puller prop or could be variably facing so as to provide yaw control in addition to, or instead of, translational thrust. It should be further understood that any such system or other translational thrust systems may alternatively or additionally be utilized.

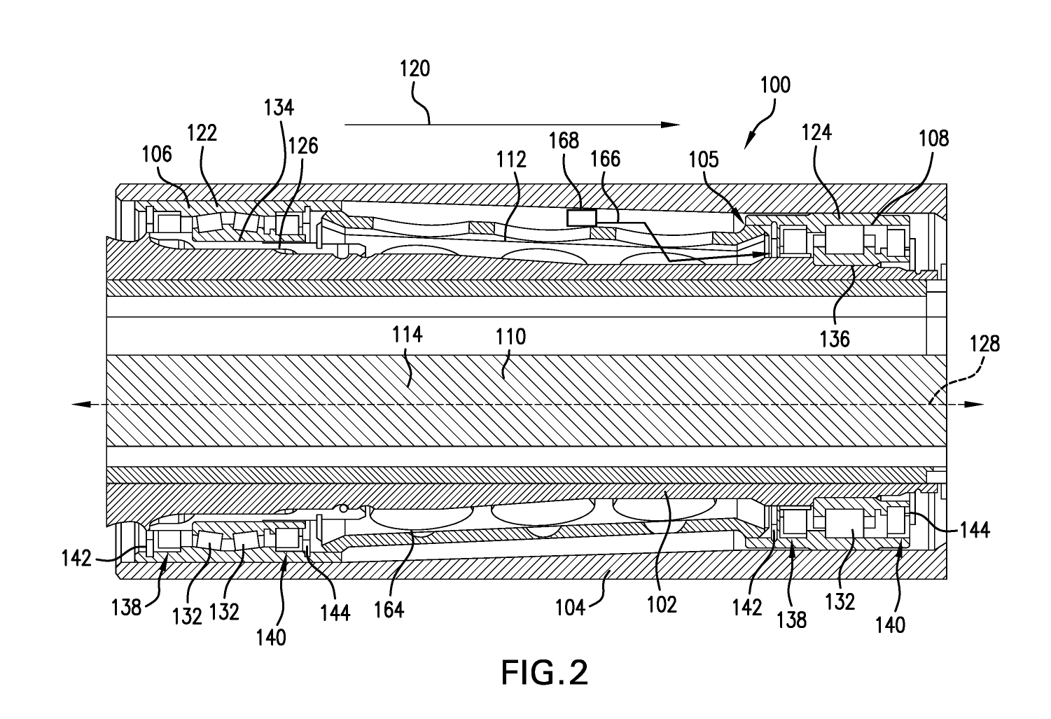

In accordance with an aspect of an exemplary embodiment, rotor system 100 may include propeller blades 104 having a variable pitch. More specifically, the pitch of propeller blades 104 may be altered with respect to the rotor hub 101, such as to change the direction of thrust (e.g., forward or rearward). Each of the rotor blades 104 can be pivoted about a respective longitudinal axis 128 (see FIG. 2) thereof by way of collective. For example, the rotor blades 104 can be controlled collectively in order to increase or decrease aircraft thrust. As noted above, the pitch change of rotor blades 15 and 16 may also be controlled.

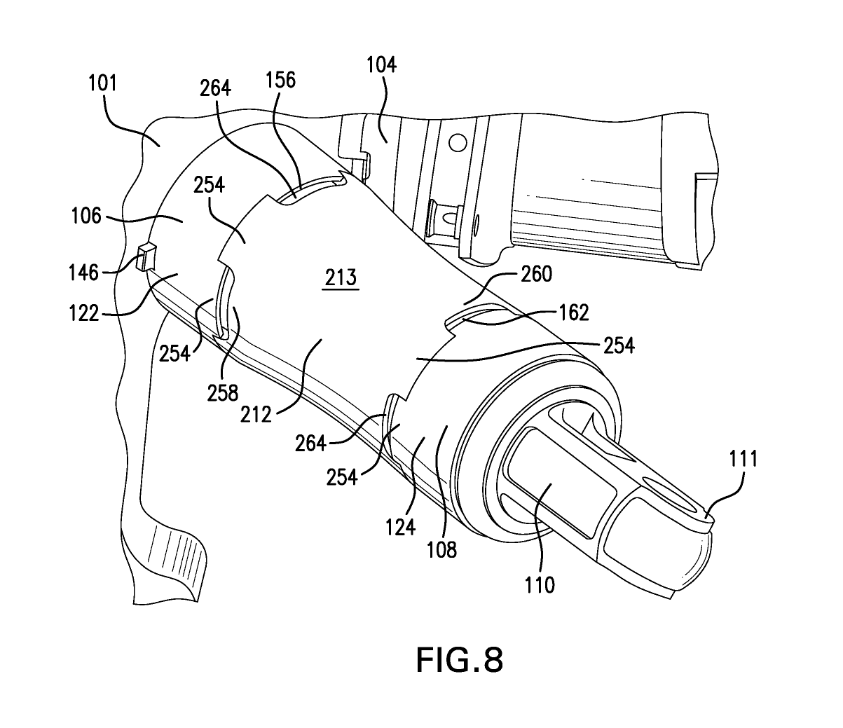

With further reference to FIGS. 2 and 8, an embodiment of the rotor system 100 is shown. While any of the rotor assemblies 22, 24 of the main rotor assembly 18 may also include the features described below, for purposes of clarity and brevity it will be assumed that the descriptions generally refer to the features and assembly of the propulsor 26, since the rotor system 100 is designed to allow large pitch ranges and is therefore suited for use in the propulsor 26. However, it will be understood that this is merely by example and that the descriptions may alternatively apply to any similar structures of the aircraft 10 or other aircraft or rotor assembly.

The rotor system 100 includes, in part, a rotor shaft and a rotor hub 101 (FIG. 8). The rotor hub 101 has one or more hub arms 102, and one or more rotor blades 104 corresponding respectively to each hub arm 102. The hub arm 102, which may be a metallic spindle integral to the rotor hub 101, extends from the rotor hub 101. The blade 104 extends over the hub arm 102 and is connected thereto by a pitch bearing assembly 105, which includes an inboard and an outboard pitch bearing 106, 108, both inside the blade spar. While the rotor system 100 may include a plurality of blades 104, only a portion of one blade 104 is shown in FIG. 2 for clarity. As additionally shown in FIG. 2, the rotor system 100 includes a tension torsion (TT) strap 110 within the hub arm 102, and further includes a coupler 112, as part of the pitch bearing assembly 105, extending longitudinally between the pitch bearings 106, 108.

The TT strap 110 restrains the centrifugal forces of the blade 104 as it rotates about the propulsor rotational axis T and roller pitch bearings 106, 108 to restrain blade bending moments. The TT strap 110 may be fixedly attached to the blade 104 at a location outboard of the hub arm 102, such as by using a fastener (not shown) that passes through an opening in a coupling 111 (FIG. 8). The TT strap 110 connects the blade 104 to the hub 101 of the rotor system 100. Further, the TT strap 110 includes an elongate body 114, fibrous materials 116, and a casing 118 (see FIG. 7). The fibrous materials 116 extend along the elongate body 114 in parallel with, or substantially parallel with, a longitudinal axis 128 of the elongate body 114. In order to reduce a weight of the TT strap 110 without sacrificing strength, the fibrous materials 116 may be formed of a lightweight material such as Kevlar™ material or other para-aramid synthetic fibers, and the fibrous materials 116 may be maintained in tension, such as by applying pretension to the TT strap 110 once the TT straps 110 are formed and installed into the rotor system 100. The TT straps 110 extend through the hub arms 102 to connect thereto. Fasteners (not shown) extending through couplings 111, or alternative connection features, may be used to connect the inboard ends of the TT straps 110 to the hub 101 and an outboard end of the TT straps 110 to the blades 104. As the rotor system 100 increases the centrifugal force, the TT strap 110 allows the blade 104 to move in the axial direction 120 while the TT strap 110 stretches axially.

In an embodiment, the inboard and outboard pitch bearings 106, 108 are angular contact bearings respectively inserted over each hub arm 102 such that an interior portion of the pitch bearing assembly 105 is rotationally fixed to the hub arm 102. The blade 104 is inserted over the outer races 122, 124 of the pitch bearings 106, 108 such that an exterior portion of the pitch bearing assembly 105 is rotationally fixed to the blade 104. Also, outer surfaces of the outer races 122, 124 and an inner surface of the blade 104 are frictionally engaged. In an embodiment where the pitch bearings 106, 108 are angular contact bearings, centrifugal force maintains the bearings 106, 108 at proper working condition. Due to the inboard and outboard pitch bearings 106, 108, the rotor system 100 is able to accommodate a large range of pitch motion, such as may be required in prop rotors, however other rotor systems, such as, but not limited to a main rotor system or other propellers may incorporate the pitch bearing assembly 105. The bearings 106, 108 are pressed over the hub arm 102 and fixed longitudinally with respect to the hub arm 102. A liner 126 may be pressed between the bearing 106 and the hub arm 102. The inner races of the pitch bearings 106, 108 do not move axially with the blade 104 during axial translation of the blade 104 when the blades 104 move axially in direction 120 due to centrifugal force. The outer races 122, 124 of the pitch bearings 106, 108 rotate with the blade 104 radially about the hub arm 102. Thus, the blade 104 is able to pitch relative to the hub arm 102. In other words, the blade 104 may partially rotate about the axis 128, in either rotational direction 130 (FIG. 7).

Each pitch bearing 106, 108 includes a plurality of roller elements 132 radially dispersed about the pitch bearing 106, 108 between an inner race 134, 136 and the outer race 122, 124. Each pitch bearing 106, 108 further includes an inboard seal 138 and an outboard seal 140 on the respective longitudinal ends of the pitch bearings 106, 108. The bearings 106, 108 are pre-greased so the seals 138, 140 hold grease within the bearings 106, 108 under the extremely high centrifugal forces they experience when the rotor system 100 is spinning. The pitch bearings 106, 108 may further include an inboard retaining ring 142 and an outboard retaining ring 144 on respective outer sides of the seals 138, 140. The outboard retaining ring 144 is there to arrest any centrifugal force trying to push the outboard seal 140 out and the inboard retaining ring 142 assists in locating and securing the inboard seal 138 during installation. In one embodiment, due to loads experienced during rotation such as bending loads that transmit through the blade 104, the inboard pitch bearing 106 may be a spherical bearing as shown, and thus includes two roller elements 132 within a longitudinal dimension of the inboard pitch bearing 106. Also in the illustrated embodiment, the outboard pitch bearing 108 is a cylindrical roller bearing which employs one cylinder riding on the outside of another cylinder, since the outboard pitch bearing 108 may see primarily radial load rather than axial load.

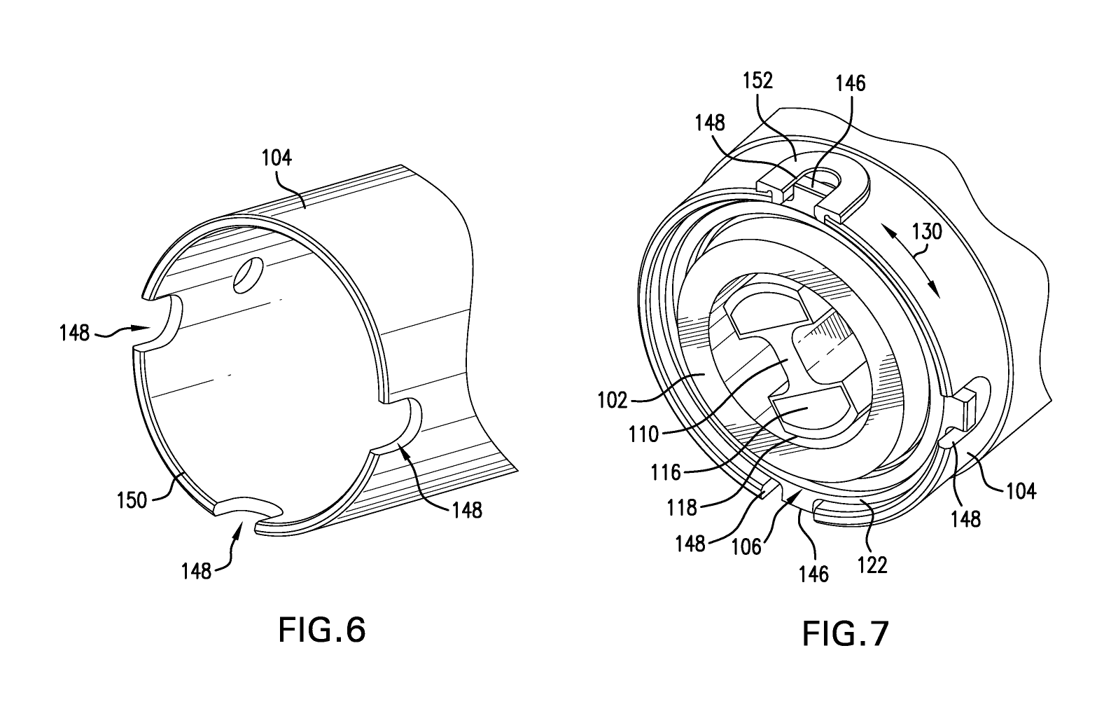

In the embodiments disclosed herein, which include the inboard and outboard pitch bearings 106, 108 as well as the tension torsion strap 110, the blade 104 is able to move axially in direction 120 with respect to the hub arm 102 and the pitch bearings 106, 108 due to centrifugal force (and are able to move axially in a direction opposite to direction 120 when the centrifugal force is reduced or removed). However, in any longitudinal location of the blades 104 with respect to the hub arm 102 and pitch bearing assembly 105, it is important that the outer races 122, 124 of the pitch bearings 106, 108 remain rotationally locked to the blade 104. Thus, in one embodiment, the rotor system 100 further includes the coupler 112 such that the bearings 106, 108 are locked to each other, and the inboard pitch bearing 106 is rotationally locked to the blade 104. As shown in FIG. 3 and FIG. 7, the inboard pitch bearing 106 has one or more tabs 146 that extend radially outwardly from the outer race 122. The blade 104 includes one or more tab-receiving areas 148 to correspondingly receive the one or more tabs 146 therein. While three tabs 146 and three tab-receiving areas 148 are illustrated in FIGS. 6 and 7, it should be understood that the number of tabs 146 and corresponding tab-receiving areas 148 may change depending on application. The tab-receiving areas 148 may be formed as notches that extend from an inboard end 150 of the blade 104. The tab-receiving areas 148 allow the blade 104 to move axially with respect to the inboard pitch bearing 106, but still locks the inboard pitch bearing 106 radially with the blade 104 since a width of the tab 146 is substantially the same as a width of the tab-receiving area 148. So as not to completely dislocate the blade 104 from the inboard pitch bearing 106, the tab-receiving area 148 is designed to have a length at least equal to or greater than an expected distance of axial translation of the blade 104. For example, if the blade 104 is expected to translate an estimated 150 thousandths of an inch due to centrifugal force, then the tab-receiving area 148 may be designed to have a longitudinal length of 250 thousandths of an inch so that the tab 146 will remain in the tab-receiving area 148 during all stages of translation of the blade 104, thus remaining rotationally fixed thereto. The rotor system 100 thus allows for axial translation of the blade 104 so that the pitch bearings 106, 108 do not take on the impact from the stretch of the TT strap 110, as they are not designed to take a load in the axial direction 120, yet the tab-receiving areas 148 stay engaged with the tabs 146 as the blade 104 translates. As rotor system 100 is slowed down and the TT strap 110 relaxes, the alignment features of the tab 146 and the tab-receiving areas 148 stay engaged as the blade 104 moves back in the direction opposite direction 120. As shown in FIG. 7, the tab-receiving areas 148 may further include a protective member 152 to protect the tab-receiving area 148 from abrasion when relative movement occurs with the tab 146.

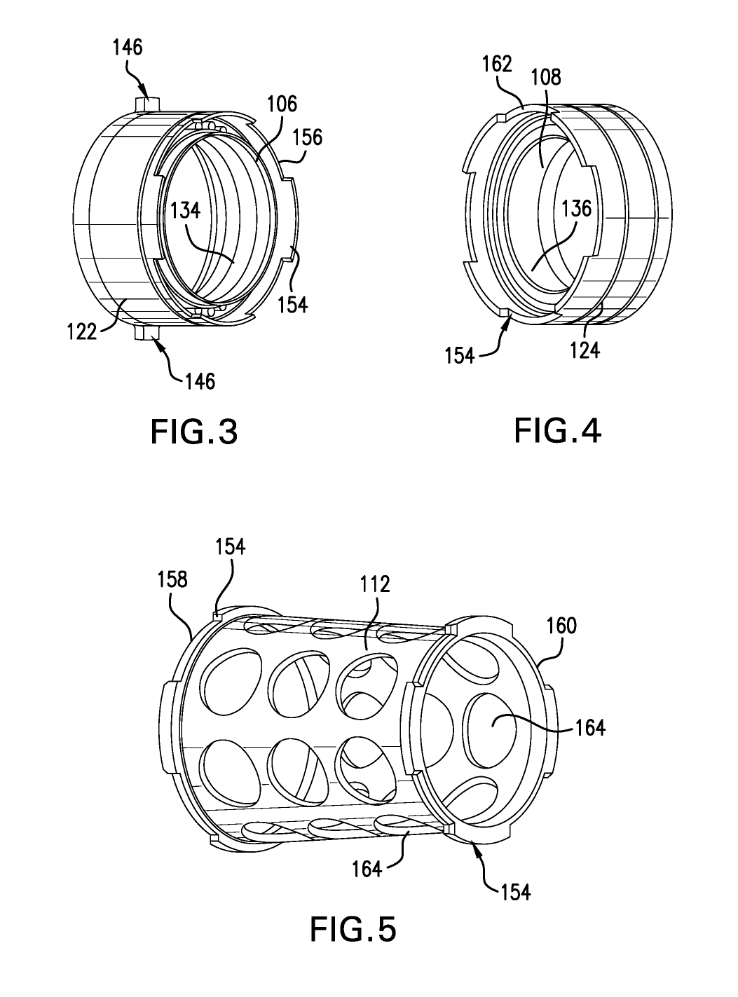

In the illustrated embodiments, because the tabs 146 are only disposed on the inboard pitch bearing 106, and because the outboard pitch bearing 108 needs to be driven as well, the coupler 112 ties in the two bearing outer races 122, 124 to each other so that they rotate together in the rotor system 100. The tabs 146 and coupler 112 are provided to mechanically and positively transfer the rotation between the bearings 106, 108 and blade 104 rather than just relying on friction between the outer races 122, 124 and the blade 104. As best shown in FIGS. 3-5, the coupler 112 includes rotation-transfer features that cooperate with corresponding rotation-transfer features on the outer races 122 and 124. In one embodiment, the rotation-transfer features include castellations 154. In particular, an outboard end 156 of the outer race 122 of the inboard pitch bearing 106 includes castellations that engage with (such as nest between) castellations 154 on an inboard end 158 of the coupler 112, and an outboard end 160 of the coupler 112 includes castellations 154 that engage with (such as nest between) castellations 154 on an inboard end 162 of the outer race 124 of the outboard pitch bearing 108. The castellations 154 are sized such that rotational movement of the outer races 122 and 124 are fixed relative to each other. In the illustrated embodiment, the castellations 154 on the coupler 112 extend in a radially outward direction while the castellations 154 on the inboard and outboard pitch bearings 106, 108 extend longitudinally in outboard and inboard directions from the outboard end 156 and inboard end 162, respectively. As one alternative to castellations 154, splines could be used, however the castellations 154 are more cost-efficient than splines and are sufficient to mechanically and rotationally lock the outer races 122, 124 and coupler 112 together to transfer the limited torsional load therebetween and make the elements pitch together.

As shown in FIGS. 2 and 5, the coupler 112 may, in one embodiment, include a plurality of openings 164. The openings 164 reduce the material required to form the coupler 112 and thus renders the coupler 112 lighter, especially if the coupler 112 is formed of metal. Also, the openings 164 closer to the outboard end 160 of the coupler 112 enable an inspection method, via an inspection path 166, of the outboard pitch bearing 108 after the rotor system 100 has been assembled, and at least after the pitch bearing assembly 105 has been assembled onto the hub arm 102. The inspection path 166 extends from an area exterior of the coupler 112 to an area interior of the coupler 112 and inboard of the outer pitch bearing 108. Also, the openings 164 closer to the inboard end 158 of the coupler 112 may enable an inspection of the outboard side of the inboard pitch bearing 106.

In another embodiment, as shown in FIG. 8, the coupler 212 may be made of a composite material to decrease the weight of the coupler 212 (as compared to a coupler of the same size made of metal), and may include a wall 213 that is non-apertured, or substantially non-apertured. In FIG. 8, one of the blades 104 is not illustrated in order to depict the pitch bearing system 105 having the coupler 212 instead of coupler 112. Since the coupler 212 does not include the openings 164 that enable bearing inspection, for bearing inspection/seal inspection of the outboard pitch bearing 108, at least one longitudinal gap 264 is disposed between the coupler 212 and the outboard pitch bearing 108. As illustrated, there may additionally be at least one longitudinal gap 264 between the coupler 212 and the inboard pitch bearing 106. The gap 264 could either be between one or more of the castellations 254 on the coupler 212 and the inboard end 162 of outer race 124 of the outboard pitch bearing 108 (and/or outboard end 156 of outer race 122 of inboard pitch bearing 106), or between the outboard end 260 of the coupler 212 and one or more of the castellations 254 of the outboard pitch bearing 108 (and/or inboard end 158 of the coupler 212 and one or more of the castellations 254 of the inboard pitch bearing 106). In a circumferential direction, the castellations 254 of the coupler 112 and outboard pitch bearing 108 and inboard pitch bearing 106 closely abut so as to transmit torque between components. Further, in this embodiment of the pitch bearing assembly including the coupler 212, the castellations 254 extend in primarily a longitudinal direction as opposed to a radial direction from their respective coupler or pitch bearing ends. However, the pitch bearing assembly is not limited in this respect. Similar to coupler 112, inspection can be performed via an inspection path through the gap 264, such as by using a borescope or a light, shown schematically at 168 in FIG. 2. In yet another embodiment, instead of employing the gap 264, one or more of the castellations 254 at the outboard end 160 (and/or at the inboard end 158) of the coupler 112 may be provided with a hole or aperture for allowing visual access to the outboard pitch bearing 108 (and/or inboard pitch bearing 106).

Thus, an aspect of the embodiments described herein includes a method of inspecting the outboard pitch bearing 108 (and/or inboard pitch bearing 106) after the rotor system 100 is assembled, or at least after the pitch bearing assembly 105 is assembled onto the hub arm 102, including a method of inspecting the seal 138 of the outboard pitch bearing 108 (and/or seal 140 of the inboard pitch bearing 106). The method includes accessing the pitch bearing 106 and/or 108 to be inspected via the inspection path 166 which begins exteriorly of the coupler 112 and ends interiorly of the coupler 112 and inboard of the outboard pitch bearing 108 (or outboard of the inboard pitch bearing 106). In embodiments of the pitch bearing assembly 105, the inspection path 166 may extend through one of an opening 164 in the coupler 112, through the longitudinal gap 264, or through a hole in one of the castellations 254. Then, the method may further include pushing a borescope 168 towards the pitch bearing 106 or 108 to be inspected, or shining a light 168 towards the pitch bearing 106 or 108 which will enable an operator to better inspect the inboard or outboard pitch bearing 106, 108, such as the seal 140 of the inboard pitch bearing 106 or the seal 138 of the outboard pitch bearing 108. While, in one embodiment, the borescope can visualize and the light can shine through the opening 164, gap 264, or castellation hole, in a further embodiment the borescope or a light (such as a flexible light) can further be inserted through the opening 164, the gap 264, or castellation hole to check the seal or other portions of the inboard or outboard pitch bearing 106, 108. Thus inspection is enabled without having to remove the whole pitch bearing assembly 105.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be further noted that the terms “first,” “second,” and the like herein do not denote any order, quantity, or importance, but rather are used to distinguish one element from another.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A pitch bearing assembly including:
an inboard pitch bearing including an inner race and an outer race, the outer race including a radially outwardly protruding tab, and an outboard end of the inboard pitch bearing including a plurality of rotation transmitting features;
an outboard pitch bearing including an inner race and an outer race, an inboard end of the outer race of the outboard pitch bearing including a plurality of rotation transmitting features; and,
a coupler having an inboard end and an outboard end, the inboard end of the coupler having a plurality of rotation transmitting features engageable with the rotation transmitting features of the inboard pitch bearing, and the outboard end of the coupler having a plurality of rotation transmitting features engageable with the rotation transmitting features of the outboard pitch bearing.

2. The pitch bearing assembly of claim 1, wherein the rotation transmitting features of the inboard end and outboard end of the coupler and the rotation transmitting features of the outer races of the inboard and outboard pitch bearings include castellations.

3. The pitch bearing assembly of claim 1, wherein the outer race of the outboard pitch bearing does not include a radially outwardly protruding tab.

4. The pitch bearing assembly of claim 1, wherein the pitch bearing assembly is disposable between a hub arm and a rotor blade of a rotor system, the inner races are rotationally fixable to the hub arm, and the outer races are rotationally fixable to the rotor blade.

5. A rotor system comprising:
a hub arm;
a blade extending in a longitudinal direction over the hub arm; and
a pitch bearing assembly disposed between the hub arm and the blade, the pitch bearing assembly including an interior portion rotationally locked to the hub arm, an exterior portion rotationally locked to the blade, the exterior portion rotatably movable with respect to the interior portion;
wherein the blade is axially translatable in the longitudinal direction with respect to the pitch bearing assembly.

6. The rotor system of claim 5, wherein the pitch bearing assembly includes:
an inboard pitch bearing having an outer race at the exterior portion of the pitch bearing assembly;
an outboard pitch bearing having an outer race; and,
a coupler rotationally fixing the outer race of the outboard pitch bearing to the outer race of the inboard pitch bearing.

7. The rotor system of claim 6, wherein the outer race of the inboard pitch bearing is rotationally fixed to the blade.

8. The rotor system of claim 7, wherein the blade includes a tab-receiving area and the outer race of the inboard pitch bearing includes a radially protruding tab seated with the tab-receiving area, the tab rotationally fixing the outer race of the inboard pitch bearing to the blade, and the tab-receiving area permitting axial translation of the blade relative to the pitch bearing assembly.

9. The rotor system of claim 8, wherein the tab-receiving area is a notch that extends from an inboard end of the blade.

10. The rotor system of claim 6, wherein the coupler includes an inboard end having a rotation transmitting feature in engagement with a rotation transmitting feature on the outer race of the inboard pitch bearing, and an outboard end having a rotation transmitting feature in engagement with a rotation transmitting feature on the outer race of the outboard pitch bearing.

11. The rotor system of claim 10, wherein the rotation transmitting features of the inboard end and outboard end of the coupler and the rotation transmitting features of the outer races of the inboard and outboard pitch bearings include castellations.

12. The rotor system of claim 6, wherein the pitch bearing assembly further includes an inspection path that extends from an exterior of the coupler to an interior of the coupler, the inspection path permitting inspection of at least one of the inboard pitch bearing and the outboard pitch bearing through the coupler.

13. The rotor system of claim 12, wherein the coupler includes an aperture providing the inspection path.

14. The rotor system of claim 12, wherein the coupler includes castellations engageable with castellations on the inboard and outboard pitch bearings, and a longitudinal gap is disposed between at least one of the castellations and one of the coupler, the inboard pitch bearing, and the outboard pitch bearing to provide the inspection path.

15. The rotor system of claim 6, wherein the inboard pitch bearing includes a spherical bearing and the outboard pitch bearing includes a cylindrical bearing.

16. The rotor system of claim 5, further comprising a tension torsion strap disposed within the hub arm, the blade axially translatable with the tension torsion strap due to centrifugal force.

17. A method of inspecting the rotor system of claim 5, the pitch bearing assembly of the rotor system including an inboard pitch bearing and an outboard pitch bearing rotationally fixed by a coupler, the method comprising:
after the pitch bearing assembly is assembled on the hub arm, employing an inspection path that extends from an exterior of the coupler to an interior of the coupler and at least one of an inboard side of the outboard pitch bearing and an outboard side of the inboard pitch bearing; and
inspecting a seal of at least one of the outboard pitch bearing and the inboard pitch bearing using the inspection path.

18. A rotary-wing aircraft comprising:
an airframe;
a rotor extending from the airframe and defining an axis of rotation;
a rotor hub surrounding the rotor, the rotor hub having a plurality of hub arms;
a plurality of rotor blades respectively engaged with the plurality of hub arms;
and, each blade extending in a longitudinal direction over a respective hub arm; and,
a pitch bearing assembly disposed between each hub arm and rotor blade, each pitch bearing assembly including an interior portion rotationally fixed to the hub arm and an exterior portion rotationally fixed to the blade, the exterior portion rotatably movable with respect to the interior portion;
wherein the plurality of rotor blades is axially translatable in the longitudinal direction with respect to each pitch bearing assembly.

19. The rotary-wing aircraft according to claim 18, wherein the pitch bearing assembly includes:
an inboard pitch bearing having an outer race;
an outboard pitch bearing having an outer race; and,
a coupler rotationally fixing the outboard pitch bearing to the inboard pitch bearing.

20. The rotary-wing aircraft according to claim 19, further comprising a tension torsion strap disposed within the hub arm, the blade axially translatable with the tension torsion strap due to centrifugal force.
